(19) United States
(12) Patent Application Publication
(10) Pub. No.: US 2008/0240674 A1
(43) Pub. Date: Oct. 2, 2008

(54) RECORDING APPARATUS

(75) Inventor: Nigel MOORE, Newbury (GB)

Correspondence Address: OBLON, SPIVAK, MCCLELLAND MAIER & NEUSTADT, P.C., 1940 DUKE STREET, ALEXANDRIA, VA, 22314, US

(73) Assignee: SONY UNITED KINGDOM LIMITED, Weybridge (GB)

(21) Appl. No.: 11/937,709

(22) Filed: Nov. 9, 2007

(30) Foreign Application Priority Data
Mar. 29, 2007 (GB) 0706230.0

(51) Int. Cl. G11B 27/02

(52) U.S. Cl. 386/64; 386/E05.005

(57) ABSTRACT

A recording apparatus 1 capable of recording television signals has a classifier system 20 operable to process television signals recorded by the recording apparatus 1 and to classify scenes of the television signal as significant or not significant. The recording apparatus allows a user to input scenes 33 associated with significance information indicating the degree of significance of the input scene 33, and the classifier system 20 is arranged to be re-trained using the input scenes 33 and associated significance information.

### BACKGROUND OF THE INVENTION

(1) Field of the Invention

The present invention relates to a recording apparatus capable of recording television signals.

(2) Description of Related Art

When a television signal is recorded, one operation which a user might wish to perform is to identify scenes of significance. The user may then reproduce or edit the television signal using the identified scenes, for example to allow reproduction of part of the television signal including or adjacent such identified scenes. Such actions may be performed automatically by the recording apparatus, for example by inserting markers at the identified scenes and controlling reproduction or editing in response to the markers.

One common example of a type of scene which may be of significance to the user is a splash screen or title screen which is positioned at the beginning or end of a part of a program adjacent a commercial break. For example, the user may wish to identify such scenes to reproduce the parts of the recorded television signal representing the program without reproducing the parts of the recording television signal representing a commercial break.

Depending on the user's interests and desires, a wide variety of other types of scene may be of significance to any given user, for example scenes which are outdoors or indoors, scenes showing particular objects or scenes with banners which are indicative of a particular item of program content.

Such identification of scenes of significance may be performed by the user himself reviewing the content of the television signal. However, the present invention is concerned with a recording apparatus which is capable of automatically identifying scenes of significance. Such a function of the recording apparatus is very useful.

### BRIEF SUMMARY OF THE INVENTION

According to the present invention, there is provided a recording apparatus capable of recording television signals,

the recording apparatus comprising a classifier system operable to process television signals recorded by the recording apparatus and to classify scenes of the television signal as significant or not significant, the classifier system being arranged to produce an output identifying the scenes classified as significant,

wherein the recording apparatus is arranged to allow a user to input scenes associated with significance information indicating the degree of significance of the input scene, and the classifier system is arranged to be re-trained using the input scenes and associated significance information.

Thus, the recording apparatus uses a classifier system to process television signals recorded by the recording apparatus and to classify scenes of the television signal as significant or not significant. The scenes classified as significant are identified by an output which may then be used by the user or by the recording apparatus for controlling reproduction and/or editing of the recorded television signals.

Training of such a classifier system may be performed by using scenes of significance and scenes not of significance as training scenes. The training is used to train or adapt the classification parameters employed by the classifier system. After the training is performed, the classifier system operates in accordance with the classification parameters to classify new television signals not previously encountered. After training the classification parameters are fixed, and typically the training scenes are not themselves stored or used for subsequent operation of the classifier system to perform classification.

Accordingly, in one scenario the manufacturer could perform the training and supply recording apparatus with a trained classifier system operating in accordance with fixed classification parameters. However this scenario would suffer from the disadvantage that the classification could not be altered. This would limit the usefulness and effectiveness of the classifier system from the point of view of classifying scenes of significance to the user. For example in the case that the scenes of significance are splash screens, although the classifier system could be trained with a variety of existing splash screens, as new splash screens are produced by television content providers the effectiveness of the classifier system in identifying the new splash screens might reduce over time. Similarly in the case of other types of scene, it would be difficult to train the classifier system to identify all scenes likely to be of interest to all viewers whose wishes will vary.

This disadvantage is overcome by allowing a user to input scenes associated with significance information indicating the degree of significance of the input scene. For example the significance information may be that all the input scenes are of significance, or more complex systems may allow the user to specify the significance for example as a binary choice of significant or not, or else by a scalar value indicating the degree of significance. Then the classifier system is re-trained using the input scenes and associated significance information. This adapts the classifier system to better identify scenes of the type input by the user. This makes the system more useful and effective from the point of view of classifying scenes of significance to the user.

To allow better understanding, an embodiment of the present invention will now be described by way of non-limitative example with reference to the accompanying drawings.

### BRIEF DESCRIPTION OF THE DRAWINGS

FIG. 1 is a diagram of a recording apparatus;

FIG. 2 is a schematic diagram illustrating the operation of a training system for a classifier system;

FIG. 3 is a flow chart of the process of using a classifier system in the recording apparatus; and

FIG. 4 is a flow chart of the process of using a training system in the recording apparatus.

### DETAILED DESCRIPTION OF THE INVENTION

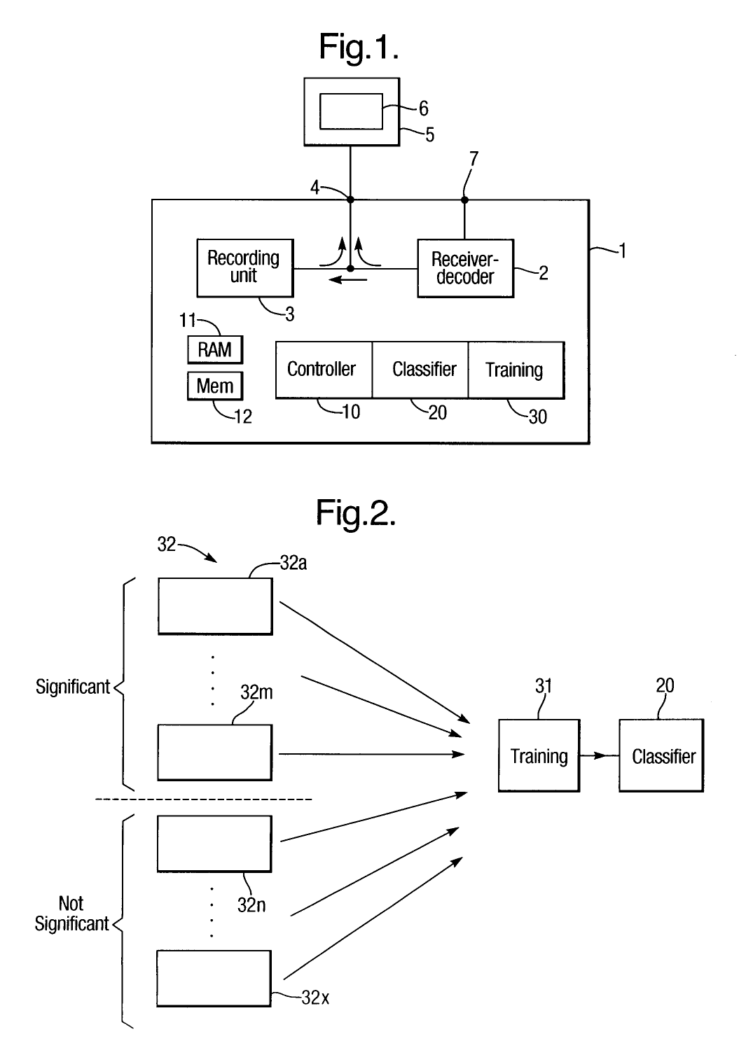

FIG. 1 shows a recording apparatus 1 comprising a receiver-decoder circuit 2 capable of receiving and decoding broadcast television signals and a recording unit 3 capable of recording the decoded television signals. The recording apparatus 1 has an output interface 4 for supply of television signals to a television apparatus 5 which displays an image on a display device. The output interface 4 may be supplied with television signals directly from the receiver-decoder circuit 2 immediately after they are decoded or else with recorded television signals reproduced from the recording unit 3. Alternatively or additionally, the display device 6 could be integrated into the recording apparatus 1.

The recording unit 3 may be of any type and capable of recording on any type of storage medium which may be integral or replaceable. Typically the recording unit 3 will be a hard drive that is integral to the apparatus or a drive for recording on an optical or magneto-optical recording medium such as a DVD.

The receiver-decoder circuit 2 is supplied with television signals received at a connector 7 of the recording apparatus 1. The connector 7 may be attached to an external antenna for the reception of terrestrial broadcast television signals, a satellite dish for reception of satellite broadcast television signals or a cable for reception of television signals over the cable. Alternatively or additionally, the television signal may be delivered over a network which may be a wired network such as the internet or a LAN or maybe a wireless network. In this case, the recording apparatus 1 is provided with a network interface arranged to receive data from the data network and to extract a television signal therefrom.

The receiver-decoder circuit 2 is arranged to receive and decode the supplied television signal. The construction of the receiver-decoder circuit 2 depends on the nature of the received television signal. For example in the case of a radio frequency (RF) broadcast television signal the receiver-decoder circuit 2 comprises an RF tuner to extract the desired transmission channel of the broadcast signal, a demodulator to demodulate the broadcast signal and extract a multiplex signal, a demultiplexer to extract a particular television signal, and a decoder to decode that television signal.

As an alternative, the receiver-decoder circuit 2 may be absent from the recording apparatus. In this case, an equivalent receiver-decoder circuit is implemented in a separate apparatus such as a set-top box or else the television apparatus 5, and the received, decoded television signal is supplied from the separate apparatus to the recording apparatus 1.

The recording apparatus 1 includes a controller 10 which controls the operation of the components of the recording apparatus 1. For example, the controller 10 controls the receiver-decoder circuit 2 to select the broadcast television signal of a desired television channel (also referred to as a “service” for example in accordance with the DVB standard). Similarly, the controller 10 controls the operation of the recording unit 3 to record television signals output by the receiver-decoder circuit 2 and to reproduce television signals which have been recorded thereon.

The recording apparatus 1 further includes a classifier system 20 and a training system 30 described below.

The controller 10, classifier system 20 and training system 30 are implemented by a microprocessor executing an appropriate computer program. The controller 10 has associated therewith a RAM 11 and a non-volatile memory 12 such as a flash memory. The computer program may be stored in the recording unit 3 or the non-volatile memory 12. The computer program may be pre-installed or may be transmitted to the recording apparatus 1 as a broadcast signal, this being a known technique for upgrading of software of a television receiving equipment.

The classifier system 20 may be operated to process television signals supplied thereto. The classifier system 20 processes successive scenes of the television signal and classifies them as being significant or not significant. The classification is performed using an artificial intelligence technique, for example a neural network. Other techniques or specific types of neural networks may be suitable for use at the classifier level in such a system. These include MLP Multilayer Perceptron, RBF Radial Basis Function, LVQ Learning Vector Quantization, SVM Support Vector Machines, SART Simplified Adaptive Resonance Theory and K-means clustering. The classifier system 20 performs the classification in accordance with a number of classification parameters which are set in a training process as will now be described.

FIG. 2 illustrates schematically the training process by which the initial values of the classification parameters of the classifier system 20 are set by a training system 31. The training system 31 is implemented by the manufacturer separately of the recording apparatus 1. The training system 31 is supplied with a plurality of training scenes 32.

The training scenes 32 may be constituted by single frames of a television signal, or alternatively by a sequence of frames of a television signal.

The training scenes 32 are each associated with significant information indicating the degree of significance of the training scenes 32. In the example of FIG. 2 the significance information is a binary value indicating that some of the scenes 32a to 32m are significant and that the remaining scenes 32n to 32x are not significant.

The training scenes 32 are selected by the manufacturer to allow the classifier system 20 to identify scenes of significance to the user, according to some criteria decided upon by the manufacturer. The scenes 32a to 32m which are deemed to be significant are selected to be representative of the type of scene which it is desired to identify. Conversely the scenes 32n to 32x which are deemed to be not significant are selected to be representative of scenes which are not of interest.

In general, the class of scenes which are deemed to be significant may be freely selected. However, one important example is that the classifier system 20 is intended to detect splash screens (or title screens) which are typically positioned at the beginning or end of a part of a program adjacent a commercial break. In this case the scenes 32a to 32m which are deemed to be significant are selected to be such splash screens and the scenes 32n to 32x which are indicated to be not significant are selected to be typical scenes of a range of television programs, for example including scenes representing a variety of different contents such as people, scenery, buildings, vehicles, sports matches, etc.

The training system 31 uses the training scenes 32 and their associated degree of significance to select the appropriate classification parameters which will allow the classifier system 20 to classify a new scene as being significant or not significant. The training system 31 uses an algorithm which is appropriate to the artificial intelligence technique employed in the classifier system 20.

Subsequently, the recording apparatus 1 is manufactured with the initial values of the classification parameters of the classifier system 20 set to the values determined by the training system 31 as just described.

In the above description it is assumed that the classification performed by the classifier system 20 is performed solely on the basis of the image data of the training scenes 32. However, optionally the classifier system 20 may additionally use other information related to the training scenes 32, so as audio information, subtitling information or metadata associated with the training scenes 32.

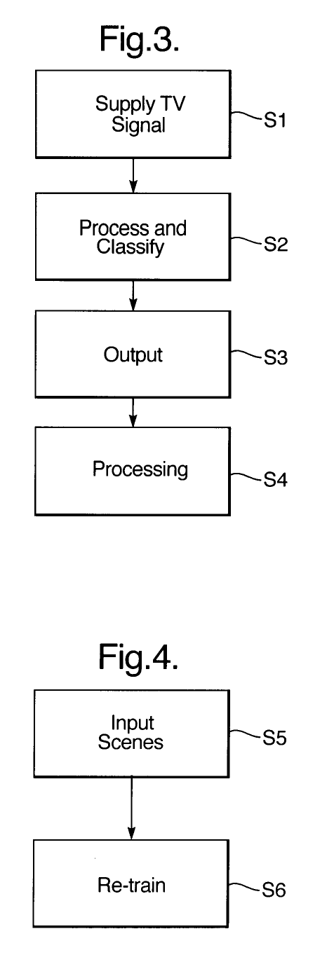

There will now be described the manner in which the classifier system 20 is used in the recording apparatus 1. In particular, the controller 10 operates the classifier system 20 using the process shown in FIG. 3 as follows.

In step S1 a television signal is supplied to the classifier system 20. The television signal may be one output by the decoder-receiver circuit 2 at the time of recording of that television signal by the recording unit 3. Alternatively, the television signal may be one reproduced from the recording unit 3 so that it is processed at a time subsequent to the time when it was recorded.

In step S2, the classifier system 20 processes the television signal by considering successive scenes of the television signal and classifying them as being significant or not significant.

In step S3, the classifier system 20 produces an output identifying those scenes which are classified as significant. The classifier system 20 may filter the results of the classification to produce a single output in step S3 when a series of temporally closely spaced scenes are classified as significant.

In step S4, the controller for a reproduction control or editing process on the basis of the output in step S3 in order to control reproduction and/or editing of the recorded television signal. A wide range of different types of processing may be performed in step S4. For example, one possible process performed in S4 is to insert markers at the locations in the television signal of the scenes identified to be significant by the output in step S3. The markers can be any suitable indicators for identifying locations, such as positional markers, flags, chapter marks and so forth. The process performed in step S4 may be automatic or may be subject to control by the user of the recording apparatus 1.

The training system 30 will now be described. The training system 30 allows the initial values of the classification parameters of the classifier system 20 to be adapted or updated. In particular, the controller 10 implements a training process using the training system 30 in the process shown in FIG. 4 as follows.

In step S5, the controller 10 allows the user to input scenes 33 associated with significance information indicating a degree of significance. This may be done by the controller 10 implementing an appropriate user interface. The scenes may be input by allowing the user to review a recorded television signal reproduced from the recording unit 3 and allowing the user to select a scene thereof. The significance information may be specified by the user. In the simplest case, all the input scenes 33 input by the user may be considered to be significant so that the associated significant information is always the same, or alternatively the user may actually input the significant information, for example by the controller 10 allowing the user to specify input scenes 33 as being significant or not significant.

In step S6, the training system 30 retrains the classifier system 20. In particular, the training system 30 performs a similar process to that performed by the training system 30 prior to manufacture, but additionally taking into account the input scenes 33 input in step S5 to improve the classification performed by the classifier system 20. As a result, the training system 30 updates the classification parameters used by the classifier system 20 on the basis of the input scenes 33. The updated parameters are then used by the classifier system 20 during subsequent operation.

The training system 30 may be used to repeatedly retrain the classifier system 20 with plural input scenes 33. The successively updated classification parameters may all be stored in association with the input scenes 33, in order to allow the updated parameters to be rolled back.

As a result of the retraining performed by the training system 30, the classifier system 20 can be trained on the basis of input scenes 33 input by the user. This allows the user to update and control the classification performed by the classifier system 20. This makes the classifier system 20 more useful and effective from the point of view of classifying scenes of significance to the user. For example, in the case that the input scenes 33 are splash screens, the user is able to input new splash screens, for example one which were not available to the manufacturer when performing the initial training in FIG. 2, with the result that the classifier system 20 may be able to identify new splash screens. Similarly, the user is able to train the classifier system 20 to identify a particular type of scene of their own choice. This adaptation would not be possible if the training system 30 were omitted and instead the classification parameters of the classifier system 20 were fixed.

One advantageous feature which may be implemented is that the process of FIG. 3 of using the classifier system 20 to process television signals may be performed automatically on television signals already recorded in the recording unit 3 each time that the training system 20 is operated with new input scenes 33 in the process of FIG. 4. This potentially allows the identification of scenes which are identifiable for the first time on the basis of the updated classification parameters.

In the above description, the classifier system 20 is described on the basis that the degree of significance is binary information, that is that a particular scene is significant or is not significant. As an alternative, the classifier system 20 may utilise a scalar value for the degree of significance.

Such a scalar value for the degree of significance may be associated with the scenes used to train the classifier system 20, that is the training scenes 32 using the initial training process of FIG. 2 and the scenes input in step S4 of FIG. 4 during retraining. Similarly, it is possible for the scenes input by the user in step S4 of FIG. 4 to be associated with a higher degree of significance than the training scenes 32 initially used to train the classifier system.

Also, the classifier system 20 may generate a result which is a scalar value indicating the degree of significance of the successive scenes of the processed television signals. In this case, the scenes may be classified as significant or not significant on the basis of whether the scalar value exceeds a threshold. In this case, the output in step S3 of FIG. 3 may include information specifying the degree of significance of the identified scenes.

1. A recording apparatus capable of recording television signals,
the recording apparatus comprising a classifier system operable to process television signals recorded by the recording apparatus and to classify scenes of the television signal as significant or not significant, the classifier system being arranged to produce an output identifying the scenes classified as significant,
wherein the recording apparatus is arranged to allow a user to input scenes associated with significance information indicating the degree of significance of the input scene, and the classifier system is arranged to be re-trained using the input scenes and associated significance information.

2. A recording apparatus according to claim 1, wherein the classifier system is operable to process television signals at the time they are recorded.

3. A recording apparatus according to claim 1, wherein the classifier system is operable to process television signals subsequent to the time when they were recorded.

4. A recording apparatus according to claim 3, wherein the classifier is operable to process the television signals which have already been recorded in the recording apparatus after the classifier has been re-trained.

5. A recording apparatus according to claim 1, wherein the recording apparatus is responsive to the output of the classifier system to insert a marker in the recorded television signal at scenes classified as significant.

6. A recording apparatus according to claim 1, wherein the significance information indicates the input scene as being significant or not.

7. A recording apparatus according to claim 1, wherein the significance information is a scalar value indicating the degree of significance of the input scene.

8. A recording apparatus according to claim 1, wherein the output of the classifier system further includes a scalar value indicating a degree of significance in respect of the scenes classified as significant.

9. A recording apparatus according to claim 1, wherein the classifier system operable to classify respective scenes of the television signal as significant or not significant using an artificial intelligence technique.

10. A recording apparatus according to claim 1, wherein the input scenes comprise single frames.

11. A recording apparatus according to claim 1, wherein the input scenes comprise sequences of frames.

12. A recording apparatus according to claim 1, wherein the recording apparatus is capable of recording television signals on an internal memory.

13. A method of operating a recording apparatus capable of recording television signals,
the method comprising:
operating a classifier system to process television signals recorded by the recording apparatus to classify scenes of the television signal as significant or not significant, and to produce an output identifying the scenes classified as significant;
accepting input from a user of scenes associated with significance information indicating the degree of significance of the input scene; and
re-training the classifier system using the input scenes and associated significance information.

14. A storage medium storing a computer program capable of execution by a recording apparatus capable of recording television signals, the computer program being arranged on execution to cause the recording apparatus to perform a method comprising:
operating a classifier system to process television signals recorded by the recording apparatus to classify scenes of the television signal as significant or not significant, and to produce an output identifying the scenes classified as significant;
accepting input from a user of scenes associated with significance information indicating the degree of significance of the input scene; and
re-training the classifier system using the input scenes and associated significance information.

15. A broadcast signal representing a computer program capable of execution by a recording apparatus capable of recording television signals, the computer program being arranged on execution to cause the recording apparatus to perform a method comprising:
operating a classifier system to process television signals recorded by the recording apparatus to classify scenes of the television signal as significant or not significant, and to produce an output identifying the scenes classified as significant;
accepting input from a user of scenes associated with significance information indicating the degree of significance of the input scene; and
re-training the classifier system using the input scenes and associated significance information.
